(19) United States
(12) Patent Application Publication
(10) Pub. No.: US 2024/0385342 A1
(43) Pub. Date: Nov. 21, 2024

(54) APPARATUS AND METHOD FOR OPTIMIZING SUBSURFACE VELOCITY MODEL

(71) Applicant: Seoul National University R&DB Foundation, Seoul (KR)

(72) Inventor: Chang Soo SHIN, Seoul (KR)

(73) Assignee: Seoul National University R&DB Foundation, Seoul (KR)

(21) Appl. No.: 18/626,303

(22) Filed: Apr. 3, 2024

Related U.S. Application Data
(60) Provisional application No. 63/466,990, filed on May 16, 2023.

(30) Foreign Application Priority Data
Feb. 23, 2024 (KR) 10-2024-0026259

(51) Int. Cl. G01V 1/30; G01V 1/28

(52) U.S. Cl. CPC G01V 1/303; G01V 1/282; G01V 2210/66

(57) ABSTRACT

An apparatus and method for optimizing a subsurface velocity model are provided to be able to optimize a velocity model by applying the Gauss Newton method through parameterization of the velocity model in exploration seismology.

### BACKGROUND OF THE INVENTION

### Field of the Invention

The present invention relates to seismic exploration technology, and more particularly to an apparatus and method for obtaining a subsurface velocity model.

### Description of the Related Art

The exploration seismology using FWI (Full Waveform Inversion) is a technique that increases a probability of finding a geological location where subsurface energy resources such as oil and natural gas are buried. In exploration seismology, a subsurface stratum structure is determined through intensive computations using seismic data, and the underground stratum structure is analyzed and visualized using a velocity model to evaluate the location and reserves of the subsurface energy resources.

To accurately analyze the underground stratum structure using FWI, the velocity model needs to be repeatedly updated to minimize an objective function (residual), which is defined as a difference between measured data by manmade seismic sources and synthetic data (synthesized modeling of wave from computer equations).

In a FWI of the exploration seismology, a good initial velocity model is crucial to both reduce the number of iterations for high resolution inversion of the seismic data and guarantee the convergence to the true velocity model.

The present inventor has conducted research on subsurface velocity model imaging technology that may obtain the velocity model by applying a Gauss Newton method through a spectral parameterization of the velocity model in exploration seismology.

Patent Document: Republic of Korea Patent No. 10-2026063 (announced on Sep. 27, 2019)

### SUMMARY OF THE INVENTION

An object of the present invention is to provide an apparatus and method for obtaining a subsurface velocity model by applying a Gauss Newton method through a spectral parameterization of the velocity model in exploration seismology.

In accordance with an aspect of the present invention, the above and other objects can be accomplished by the provision of an apparatus for obtaining an good initial subsurface velocity model including a nonvolatile memory configured to store execution code for obtaining the good initial velocity model software, a processor configured to execute the execution code for obtaining the good initial subsurface velocity model software stored in the nonvolatile memory, a display configured to display a software for obtaining the initial subsurface velocity model output by the execution code for the technique obtaining the good initial subsurface velocity model software executed by the processor, and a user input unit configured to receive user operation for input and output of the software of obtaining the good initial subsurface velocity model, wherein a finding of good initial subsurface velocity model software includes a parameterization section configured to parametrize a velocity model, and a velocity model optimization section configured to applying a Gauss Newton method through waveform inversion for the velocity model parameterized by the parameterization section to repeatedly update the velocity model, thereby obtaining the good initial subsurface velocity model.

The parameterization section may include a partial differentiation of the subsurface velocity model configured to parameterize a velocity function included in a wave equation in a frequency domain or the Laplace domain or the Laplace Fourier domain and to take partial derivative of the subsurface velocity function with respect to a parameter, and a synthetic seismic data generation section configured to generate synthetic seismic data from a partial differentiation result by the partial differentiation section of the subsurface velocity function.

The velocity model optimization section may include a residual definition section configured to define a residual between the measured seismic data and the synthetic seismic data, a partial differentiation section configured to partially differentiate the synthetic seismic data with respect to a coefficient of cosine transform, sine transform or complex Fourier series or Fourier transform and a velocity model update section configured to apply the Gauss Newton method and to update the velocity model.

The velocity model update section may find the good initial velocity model by repeatedly updating the velocity model until the residual is minimized.

In accordance with another aspect of the present invention, there is provided a method of optimizing a subsurface velocity model including parameterizing a velocity model in exploration seismology, and using Gauss Newton method through waveform inversion for the velocity model parameterized by the parameterizing to repeatedly update the velocity model, thereby optimizing the good initial velocity model.

The parameterizing may include parameterizing a velocity function included in a wave function in a frequency domain or a Laplace domain or a Laplace Fourier domain and taking partial derivative of the parameterized velocity function with respect to a parameter, and generating synthetic seismic data from a partial differentiation result by the parameterizing a velocity function.

The Gauss Newton method may include defining a partial derivative of the synthetic seismic data and the synthetic seismic data, taking partial derivative of the synthetic seismic data with respect to a coefficient of cosine transform, since transform or the complex Fourier series or the Fourier transform. then applying the Gauss Newton method, and updating the velocity model.

The Gauss Newton method include optimizing the velocity model by repeatedly updating the velocity model until the residual is minimized.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a configuration of an embodiment of a subsurface velocity model optimization apparatus according to the present invention;

FIG. 2 is a block diagram illustrating a configuration of an embodiment of subsurface velocity model optimization software executed by the subsurface velocity model optimization apparatus according to the present invention; and

FIG. 3 is a flowchart illustrating a configuration of an embodiment of a method of optimizing the subsurface velocity model according to the present invention.

### DETAILED DESCRIPTION OF THE INVENTION

Hereinafter, the present invention will be described in detail through preferred embodiments described with reference to the attached drawings so that those skilled in the art may easily understand and reproduce the embodiments. Even though specific embodiments are illustrated in the drawings and related detailed descriptions are given, the specific embodiments are not intended to limit various embodiments of the present invention to any particular form.

In describing the present invention, when it is determined that a detailed description of a related known function or configuration may unnecessarily obscure the gist of the embodiments of the present invention, the detailed description will be omitted.

When a component is mentioned as being “coupled” or “connected” to another component, it is understood that the component may be directly coupled or connected to another component, and still another component may be present therebetween.

On the other hand, when a component is mentioned as being “directly coupled” or “directly connected” to another component, it should be understood that there are no other components therebetween.

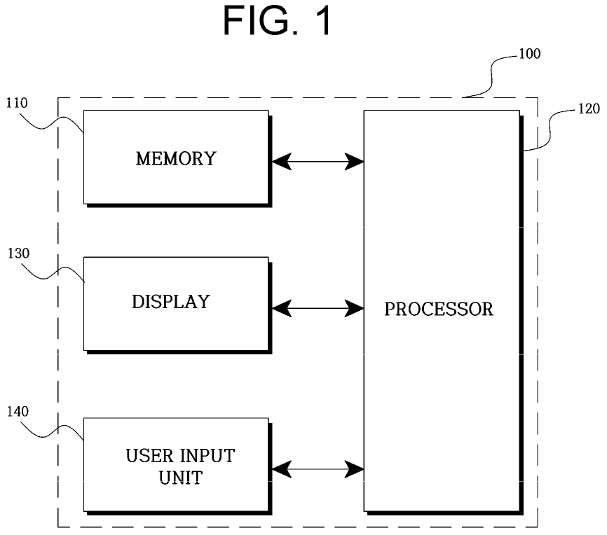

FIG. 1 is a block diagram illustrating a configuration of an embodiment of a subsurface velocity model optimization apparatus according to the present invention. As illustrated in FIG. 1, a subsurface velocity model optimization apparatus 100 according to this embodiment includes a nonvolatile memory 110, a processor 120, a display 130, and a user input unit 140.

The nonvolatile memory 110 stores execution code for subsurface velocity model optimization software 200. For example, the nonvolatile memory 110 may be a flash memory, an EEPROM, etc.

The processor 120 executes the execution code for the subsurface velocity model optimization software 200 stored in the nonvolatile memory 110. In this instance, the processor 120 may be a single core processor or a multicore processor.

The display 130 displays a subsurface velocity model optimization software screen output by the execution code for the subsurface velocity model optimization software 200 executed by the processor 120. For example, the display 130 may be an LED, an OLED, etc. However, the display 130 is not limited thereto.

The user input unit 140 receives user operations for input and output of the subsurface velocity model optimization software 200. For example, the user input unit 140 may be a keyboard, a mouse, a touch panel, etc. However, the user input unit 140 is not limited thereto.

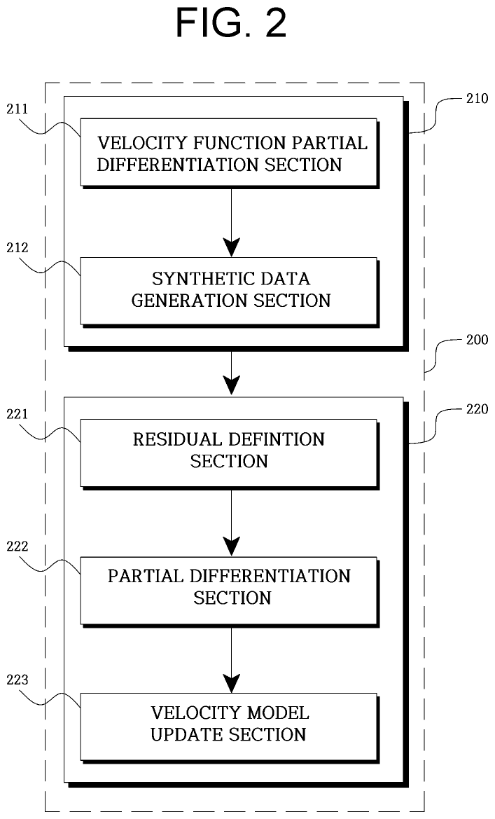

FIG. 2 is a block diagram illustrating a configuration of an embodiment of the subsurface velocity model optimization software executed by the subsurface velocity model optimization apparatus according to the present invention. As illustrated in FIG. 2, the subsurface velocity model optimization software 200 according to this embodiment includes a parameterization section 210 and a velocity model optimization section 220.

The parameterization section 210 selects an initial velocity model of all exploration methods including exploration seismology and performs parameterization for the selected initial velocity model. In this instance, the parameterization section 210 may include a velocity function partial differentiation section 211 and a synthetic data generation section 212.

The velocity function partial differentiation section 211 parameterizes a velocity function included in a wave equation in the frequency domain or the Laplace domain or the Laplace Fourier domain and take partial derivative the parameterized velocity function with respect to a parameter.

$$\frac{{\partial }^{2} u}{\partial {z}^{2}} + \frac{{ω}^{3}}{{v}^{3}} u = f ( z ) \qquad ( Equation 1 )$$

Equation 1 expresses a one-dimensional wave equation in the frequency domain. In Equation 1, v denotes velocity function, and when the reciprocal of the square of the velocity function is set to s (z), Equation 1 is expressed as Equation 2.

$$\frac{{\partial }^{2} u}{\partial {z}^{2}} + s ( z ) {ω}^{2} u = f ( z ) \qquad ( Equation 2 )$$

Each element (matrix coordinate) of a matrix of a 1D wave equation, a two-dimensional (2D) wave equation, or a three-dimensional (3D) wave equation may be expressed in the form of a straight line, a square, or a cuboid having an underground velocity.

A velocity column of the matrix of the 1D wave equation may be expressed in the form of Fourier series, Fourier transform, cosine transform, sine transform, generalized Fourier series: Chebyshev polynomials, Hermitian polynomials, Laguerre polynomial, spherical harmonics function, spherical Bessel function, etc.

Equation 3 expresses the velocity function v (z) of the 1D wave equation in the form of Fourier Transform.

$$v ( z ) = {\sum }_{n = - ∞}^{∞} {a}_{n} {e}^{\frac{in π z}{l}} \qquad ( Equation 3 )$$

Equation 3 means that a value of a partial derivative of a wave field (Synthetic seismic data) may be obtained by parameterizing a Fourier coefficient aₙ of the velocity function aᵢ, i=−∞, . . . , ∞.

When the velocity function of Equation 3 is processed using a low pass filter (LPF), Equation 4 is obtained.

$$v ( z ) ≅ {\sum }_{n = - N}^{n = N} {a}_{n} {e}^{\frac{in π z}{l}} \qquad ( Equation 4 )$$

When Equation 4 is taken partial derivative with respect to the Fourier coefficient aₙ, Equation 5 is obtained.

$$\frac{d \frac{1}{v ( z )}}{{da}_{n}} = \frac{- 2 {e}^{\frac{in π z}{l}}}{{( {\sum }_{n = - N}^{n = N} {a}_{n} {e}^{\frac{in π z}{l}} )}^{2}} \qquad ( Equation 5 )$$

When Equation 5 is substituted into Equation 1, Equation 6 is obtained.

$$\frac{{\partial }^{2} u}{\partial {z}^{2}} + \frac{1}{{( {\sum }_{n = - N}^{n = N} {a}_{n} {e}^{\frac{in π z}{l}} )}^{2}} {ω}^{2} u = f ( z ) \qquad ( Equation 6 )$$

When Equation 6 is taken partial derivative with respect to the Fourier coefficient aₙ, a real part is expressed as Equation 7-1, and an imaginary part is expressed as Equation 7-2.

$$\frac{{\partial }^{2} {u}^{′}}{\partial {z}^{2}} + ( \frac{1}{{( {\sum }_{n = - N}^{n = N} {a}_{n} {e}^{\frac{in π z}{l}} )}^{2}} ) {ω}^{2} {u}^{′} + \frac{- 2 {e}^{\frac{in π z}{l}}}{{( {\sum }_{n = - N}^{n = N} {a}_{n} {e}^{\frac{in π z}{l}} )}^{2}} {ω}^{2} u = 0. \qquad ( Equation 7 - 1 )$$

In Equation 7-1, n=−N, . . . ,0, . . . , N,

$${u}^{′} = \frac{\partial u}{\partial {a}_{n}} ,$$

aₙ=rₙ, and rₙ is a real part of the Fourier coefficient aₙ.

$$\frac{{\partial }^{2} {u}^{′}}{\partial {z}^{2}} + ( \frac{1}{{( {\sum }_{n = - N}^{n = N} {a}_{n} {e}^{\frac{in π z}{l}} )}^{2}} ) {ω}^{2} {u}^{′} + \frac{- 2 \text{?} {e}^{\frac{in π z}{l}}}{{( {\sum }_{n = - N}^{n = N} {a}_{n} {e}^{\frac{in π z}{l}} )}^{2}} {ω}^{2} u = 0 \qquad ( Equation 7 - 2 )$$

$$\text{?} \text{indicates text missing or illegible when filed}$$

In Equation 7-2, n=−N, . . . ,0, . . . , N,

$${u}^{′} = \frac{\partial u}{\partial {a}_{n}} ,$$

aₙ=iₙ, and iₙ is an imaginary part of the Fourier coefficient aₙ.

The synthetic seismic data generation section 212 generates synthetic seismic data (virtual source field) from a partial differentiation result by the velocity function partial differentiation section 211.

When the third term of Equations 7-1 and 7-2 is shifted to the right, Equations 8-1 and 8-2 are obtained.

$$\frac{{\partial }^{2} {u}^{′}}{\partial {z}^{2}} + ( \frac{1}{{( {\sum }_{n = - N}^{n = N} {a}_{n} {e}^{\frac{in π z}{l}} )}^{2}} ) {ω}^{2} {u}^{′} = - \frac{2 {e}^{\frac{in π z}{l}}}{{( {\sum }_{n = - N}^{n = N} {a}_{n} {e}^{\frac{in π z}{l}} )}^{2}} {f}^{*} \qquad ( Equation 8 - 1 )$$

In Equation 8-1, n=−N, 0,1,2, . . . N, and f^{k} denotes virtual earthquake data.

$$\frac{{\partial }^{2} {u}^{′}}{\partial {z}^{2}} + ( \frac{1}{{( {\sum }_{n = - N}^{n = N} {a}_{n} {e}^{\frac{in π z}{l}} )}^{2}} ) {ω}^{2} {u}^{′} = - \frac{2 \text{?} {e}^{\frac{in π z}{l}}}{{( {\sum }_{n = - N}^{n = N} {a}_{n} {e}^{\frac{in π z}{l}} )}^{2}} {f}^{*} \qquad ( Equation 8 - 2 )$$

$$\text{?} \text{indicates text missing or illegible when filed}$$

In Equation 8-2, n=−N, 0,1,2, . . . N, and f^{k} denotes virtual earthquake data.

The velocity model optimization section 220 apply Gauss Newton Method through waveform inversion for the velocity model parameterization parameterized by the section 210 to repeatedly update the velocity model, thereby optimizing the velocity model. In this instance, the velocity model optimization section 220 may include a residual definition section 221, a partial differentiation section 222, and a velocity model update section 223.

The residual definition section 221 defines a residual of the measured seismic data and the synthetic seismic data.

The partial differentiation section 222 configured to take partial derivative the synthetic seismic data or the wavefield with respect to a coefficient of cosine transform or since transform or the complex Fourier series or the Fourier transform.

The velocity model update section 223 configured to applying the Gauss Newton method to update the velocity model. In this instance, the velocity model update section 223 may be implemented to optimize the velocity model by repeatedly updating the velocity model until the residual is minimized.

For example, the velocity model update section 223 may be implemented to optimize the velocity model by repeatedly updating the velocity model until the residual, that is, an error, is minimized using the Gauss-Newton Method (Pratt et al, 1988). The Gauss-Newton Method is a method of repeatedly solving a solution through the following Equations 12 and 13.

$${p}^{( k + 1 )} = {p}^{( k )} - {H}_{a}^{- 1} {∇}_{p} E or δp = - {H}_{a}^{- 1} {∇}_{p} E \qquad ( Equation 12 )$$

$$H = {J}^{T} J \qquad ( Equation 13 )$$

In Equations 12 and 13, p denotes a velocity model matrix element, H denotes an approximate Hessian matrix, E denotes a residual, which is an objective function, ∇ₚE denotes a gradient of the residual, which is the objective function, and J denotes a Jacobian matrix.

The velocity model update section 223 may optimize the velocity model by repeatedly updating the velocity model until the residual is minimized using Equation 12 and Equation 13.

The 1D wave equation has been described above as an example. However, a 2D wave equation may be applied as follows.

$${∇}^{2} u + \frac{1}{\{ ( {\sum }_{n = - N}^{n = N} {\sum }_{m = - M}^{M} {a}_{nm} {e}^{in π x / N} {e}^{{im π y / M ) \}}^{2}}} {ω}^{2} u = f ( x , z ) \qquad ( Equation 14 )$$

Equation 14 is a 2D wave equation in the frequency domain, where N denotes a length of a horizontal distance of the velocity model, and M denotes a length of a vertical distance of the velocity model.

When Equation 14 is partially differentiated with respect to a 2D Fourier coefficient as in the case of the 1D wave equation described above, a real part is expressed as Equation 15-1, and an imaginary part is expressed as Equation 15-2.

$${∇}^{2} \frac{\partial u}{\partial {a}_{n}} + \frac{1}{{\{ ( {\sum }_{n = - N}^{n = N} {\sum }_{m = - M}^{M} {a}_{nm} {e}^{in π x / N} {e}^{im π y / M} ) \}}^{2}} {ω}^{2} \frac{\partial u}{\partial {a}_{n}} = - {ω}^{2} \frac{- 2 {e}^{in π x / N} {e}^{im π y / M}}{{\{ ( {\sum }_{n = - N}^{n = N} {\sum }_{m = - M}^{M} {a}_{nm} {e}^{in π x / N} {e}^{im π y / M} ) \}}^{2}} u \qquad ( Equation 15 - 1 )$$

$${∇}^{2} \frac{\partial u}{\partial {a}_{n}} + \frac{1}{{\{ ( {\sum }_{n = - N}^{n = N} {\sum }_{m = - M}^{M} {a}_{nm} {e}^{in π x / N} {e}^{im π y / M} ) \}}^{2}} {ω}^{2} \frac{\partial u}{\partial {a}_{n}} = - {ω}^{2} \frac{- 2 \text{?} {e}^{in π x / N} {e}^{im π y / M}}{{\{ ( {\sum }_{n = - N}^{n = N} {\sum }_{m = - M}^{M} {a}_{nm} {e}^{in π x / N} {e}^{im π y / M} ) \}}^{2}} u \qquad ( Equation 15 - 2 )$$

$$\text{?} \text{indicates text missing or illegible when filed}$$

In Equations 15-1 and 15-2, n=−N, . . . ,0, . . . . ,N, m=−M,. . . ,0, . . . ,M.

Meanwhile, a 3D wave equation may be applied as follows.

$${∇}^{2} u + \frac{1}{{( {\sum }_{n = - N}^{n = N} {\sum }_{m = - M}^{m = M} {\sum }_{l = \_ L}^{l = L} {e}^{in π x / N} {e}^{in π y / M} {e}^{in π z / L} )}^{2}} {ω}^{2} u = f ( x , y , z ) \qquad ( Equation 16 )$$

When Equation 16 is taken partial derivate with respect to a 3D Fourier coefficient as in the case of the 1D wave equation described above, a real part is expressed as Equation 17-1, and an imaginary part is expressed as Equation 17-2.

$${∇}^{2} \frac{\text{?}}{\text{?}} + {ω}^{2} \frac{1}{{( {\sum }_{\text{?}}^{\text{?}} {\sum }_{\text{?}}^{\text{?}} {\sum }_{\text{?}}^{\text{?}} {e}^{\text{?}} {e}^{\text{?}} {e}^{\text{?}} )}^{2}} \frac{\text{?}}{\text{?}} = - {ω}^{2} \frac{2 {e}^{\text{?}} {e}^{\text{?}} {e}^{\text{?}}}{{( {\sum }_{\text{?}}^{\text{?}} {\sum }_{\text{?}}^{\text{?}} {\sum }_{\text{?}}^{\text{?}} {e}^{\text{?}} {e}^{\text{?}} {e}^{\text{?}} )}^{2}} u \qquad ( Equation 17 - 1 )$$

$${∇}^{2} \frac{\text{?}}{\text{?}} + {ω}^{2} \frac{1}{{( {\sum }_{\text{?}}^{\text{?}} {\sum }_{\text{?}}^{\text{?}} {\sum }_{\text{?}}^{\text{?}} {e}^{\text{?}} {e}^{\text{?}} {e}^{\text{?}} )}^{2}} \frac{\text{?}}{\text{?}} = - {ω}^{2} \frac{2 \text{?} {e}^{\text{?}} {e}^{\text{?}} {e}^{\text{?}}}{{( {\sum }_{\text{?}}^{\text{?}} {\sum }_{\text{?}}^{\text{?}} {\sum }_{\text{?}}^{\text{?}} {e}^{\text{?}} {e}^{\text{?}} {e}^{\text{?}} )}^{2}} u \qquad ( Equation 17 - 2 )$$

$$\text{?} \text{indicates text missing or illegible when filed}$$

In Equations 17-1 and 17-2 n=−N, . . . 0,1,N,m=−M, . . . ,o . . . M,l=−L, . . . ,0, . . . ,L

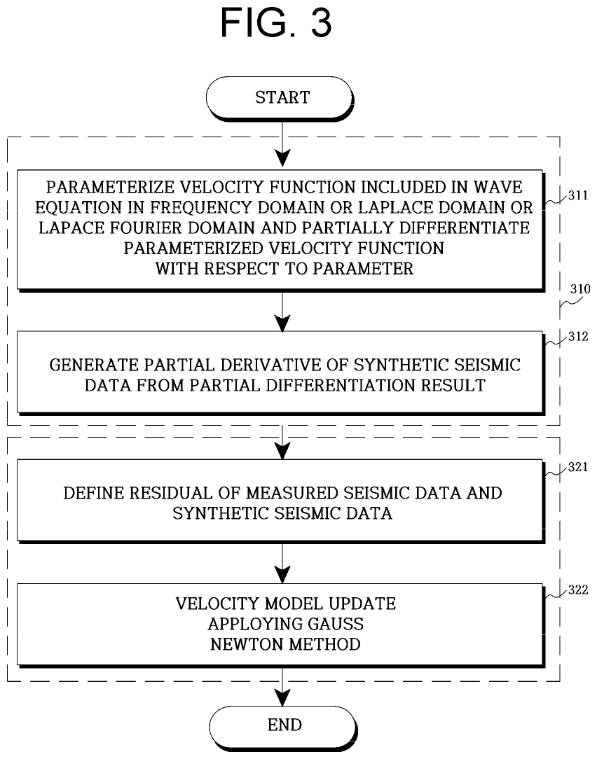

A subsurface velocity model optimization operation of the subsurface velocity model optimization apparatus according to the present invention described above will be described through FIG. 3. FIG. 3 is a flowchart illustrating a configuration of an embodiment of a method of optimizing the subsurface velocity model according to the present invention.

First, in a parameterization step 310, the subsurface velocity model optimization apparatus performs parameterization for all velocity models of exploration, including exploration seismology. In this instance, the parameterization step 310 may include a velocity function partial differentiation step 311 and a synthetic seismic data generation step 312.

In the partial differentiation step 311, the subsurface velocity model optimization apparatus parameterizes the velocity function included in the wave equation in the frequency domain or the Laplace domain or the Laplace Fourier domain and partially differentiates the parameterized velocity function with respect to a parameter. A description related thereto has been given using equations, and thus redundant description will be omitted.

In the synthetic seismic data generation step 312, the subsurface velocity model optimization apparatus generates virtual earthquake data from a partial differentiation result by the partial differentiation of the velocity function step 311. A description related thereto has been given using equations, and thus redundant description will be omitted.

Next, in the velocity model optimization step 320, the subsurface velocity model optimization apparatus derives a steepest descent direction or the Gauss Newton method through waveform inversion for the velocity model parameterized in the parameterization step 310 to repeatedly update the velocity model, thereby optimizing the velocity model. In this instance, the velocity model optimization step 320 may include a residual definition step 321, a partial differentiation step 322, and a velocity model update step 323.

In the residual definition step 321, the subsurface velocity model optimization apparatus defines a residual, a difference between the measured seismic data and the synthetic seismic data. A description related thereto has been given using equations, and thus redundant description will be omitted.

In the partial differentiation step 322, the subsurface velocity model optimization apparatus partially differentiates the residual defined by the residual definition step 321 with respect to a coefficient of cosine transform or sine transform of the complex Fourier Series or the Fourier Transform. A description related thereto has been given using equations, and thus redundant description will be omitted.

In this instance, in the velocity model update step 323, the velocity model is optimized by repeatedly updating the velocity model until the residual is minimized.

For example, in the velocity model update step 323, implementation may be performed to optimize the velocity model by repeatedly updating the velocity model until the residual, that is, an error, is minimized using the Gauss-Newton Method.

By this implementation, the present invention may optimize the velocity model of the exploration seismology, so that features or properties related to the underground stratum structure may be analyzed more accurately and efficiently.

The various embodiments in this disclosed specification and drawings are merely presented as specific examples to aid understanding, and are not intended to limit the scope of the various embodiments of the present invention.

Accordingly, the scope of the various embodiments of the present invention should be interpreted as including all changed or modified forms derived based on the technical idea of the various embodiments of the present invention in addition to the embodiments described herein.

The present invention may be industrially used in the field of technology related to exploration seismology and application technology thereof.

What is claimed is:

1. An apparatus for optimizing a subsurface velocity model, the apparatus comprising:
a nonvolatile memory configured to store execution code for subsurface velocity model optimization software;
a processor configured to execute the execution code for the subsurface velocity model optimization software stored in the nonvolatile memory;
a display configured to display a subsurface velocity model optimization software screen output by the execution code for the subsurface velocity model optimization software executed by the processor; and
a user input unit configured to receive user operation for input and output of the subsurface velocity model optimization software,
wherein the subsurface velocity model optimization software comprises:
a parameterization section configured to parametrize a velocity model; and
a velocity model optimization section configured to applying a Gauss Newton method through waveform inversion for the velocity model parameterized by the parameterization section to repeatedly update the velocity model, thereby obtaining the good initial subsurface velocity model.

2. The apparatus according to claim 1, wherein the parameterization section comprises:
the partial differentiation of a velocity function section configured to parameterize a velocity function included in a wave equation in a frequency domain or the Laplace domain or the Laplace Fourier domain to take partial derivative the parameterized velocity function with respect to a parameter; and
a synthetic data generation section configured to generate synthetic seismic data from a partial differentiation result by of the partial differentiation of the velocity function section.

3. The apparatus according to claim 2, wherein the velocity model optimization section comprises:
a residual definition section configured to define a residual of measured seismic data and the synthetic seismic data;
a partial differentiation section configured to take partial derivative the synthetic seismic data or the wavefield with respect to a coefficient of cosine transform or since transform or the complex Fourier series or the Fourier transform; and
a velocity model update section configured to applying the Gauss Newton method to update the velocity model.

4. The apparatus according to claim 3, wherein the velocity model update section optimizes the velocity model by repeatedly updating the velocity model until the residual is minimized.

5. A method of optimizing a subsurface velocity model, the method comprising:
parameterizing a velocity model; and
velocity model optimizing configured to applying a Gauss Newton method through waveform inversion for the velocity model parameterized by the parameterizing to repeatedly update the velocity model, thereby optimizing the velocity model.

6. The method according to claim 5, wherein the parameterizing comprises:
parameterizing a velocity function included in a wave function in a frequency domain or a Laplace or a Laplace Fourier domain, and taking partial derivative of the parameterized velocity function with respect to a parameter; and generating the synthetic seismic data from a partial differentiation result by the parameterizing a velocity function.

7. The method according to claim 6, wherein the velocity model optimizing comprises:
defining a residual of the measured seismic data and the synthetic seismic data;
partial differentiating which takes partial derivative the synthetic seismic data or the wavefield with respect to a coefficient of cosine transform or since transform or the complex Fourier series or the Fourier transform; and
a velocity model updating which apply the Gauss Newton method and update the velocity model.

8. The method according to claim 7, wherein the Gauss Newton method comprises optimizing the velocity model by repeatedly updating the velocity model until the residual is minimized.
